(19) United States
(12) Patent Application Publication
(10) Pub. No.: US 2026/0079771 A1
(43) Pub. Date: Mar. 19, 2026

(54) OPTIMIZING PARAMETER EXTRACTION

(71) Applicant: QUALCOMM Incorporated, San Diego, CA (US)

(72) Inventors: Anantharaman BALASUBRAMANIAN, San Diego, CA (US); Amr Mamoun MARTINI, San Diego, CA (US); Arvind Vardarajan SANTHANAM, San Diego, CA (US); Jonathan Yang SHUAI, Irvine, CA (US); Afshin ABDI, San Diego, CA (US)

(21) Appl. No.: 18/887,580

(22) Filed: Sep. 17, 2024

(51) Int. Cl. G06F 9/54

(52) U.S. Cl. CPC G06F 9/541

(57) ABSTRACT

Systems and techniques are described herein for optimizing parameter extraction. For instance, a method for optimizing parameter extraction is provided. The method can include predict, based on a first query and a set of keys of an application programming interface, a subset of keys associated with the first query from the set of keys, wherein the subset of keys comprises a first key and a second key; extract, from the first query, a first value for the first key; extract, from the first query, a second value for the second key; and provide the first value and the second value to the application programming interface to perform a function based on the first value and the second value.

### FIELD

The present disclosure generally relates to techniques for optimizing parameter extraction. For example, aspects of the present disclosure relate to systems and techniques for optimizing parameter extraction (e.g., for application programming interface (API) calling).

### BACKGROUND

Machine learning models can be designed to process textual content to learn to recognize and classify textual elements, such as words, punctuation, phrases, and so forth. One such example of a machine learning model configured to process textual content is a large language model (LLM). Machine learning models, including LLMs, can be further designed to generate text based on the textual content. As an example, a machine learning model can be trained to perform natural language processing tasks, such as generating, predicting, translating, etc. text.

In some examples, machine learning models can be implemented using neural networks (NN), such as transformer models. A transformer model can be a type of machine learning model (e.g., a NN) including an encoder and decoder and may be used to tokenize inputs, learn relationships between the tokens, and then generate predictions using the tokens. Some machine learning models, such as LLMs, are relatively large models. Large models can be resource intensive to execute. Large models can also be prone to hallucinations (e.g., inaccuracies in predictions or outputs). The resource intensive nature of machine learning models makes some machine learning models difficult to integrate into smartphones and other portable electronics, which often lack the same memory and computational power compared to other electronic devices.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for optimizing parameter extraction. In some aspects, an apparatus for optimizing parameter extraction is provided that includes at least one memory and at least one processor (e.g., configured in circuitry) coupled to the at least one memory. The at least one processor can be configured to: predict, based on a first query and a set of keys of an application programming interface, a subset of keys associated with the first query from the set of keys, wherein the subset of keys comprises a first key and a second key; extract, from the first query, a first value for the first key; extract, from the first query, a second value for the second key; and provide the first value and the second value to the application programming interface to perform a function based on the first value and the second value.

In some aspects, a method is provided for optimizing parameter. The method includes: predicting, based on a first query and a set of keys of an application programming interface, a subset of keys associated with the first query from the set of keys, wherein the subset of keys comprises a first key and a second key; extracting, from the first query, a first value for the first key; extracting, from the first query, a second value for the second key; and providing the first value and the second value to the application programming interface to perform a function based on the first value and the second value.

In some aspects, a non-transitory computer-readable medium is provided that has stored thereon instructions that, when executed by one or more processors, cause the one or more processors to: predict, based on a first query and a set of keys of an application programming interface, a subset of keys associated with the first query from the set of keys, wherein the subset of keys comprises a first key and a second key; extract, from the first query, a first value for the first key; extract, from the first query, a second value for the second key; and provide the first value and the second value to the application programming interface to perform a function based on the first value and the second value.

In some aspects, an apparatus for optimizing parameter extraction is provided. The apparatus includes: means for predicting, based on a first query and a set of keys of an application programming interface, a subset of keys associated with the first query from the set of keys, wherein the subset of keys comprises a first key and a second key; means for extracting, from the first query, a first value for the first key; means for extracting, from the first query, a second value for the second key; and means for providing the first value and the second value to the application programming interface to perform a function based on the first value and the second value.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 illustrates an example implementation of a system-on-a-chip (SOC), in accordance with aspects of the present disclosure;

FIG. 2A illustrates an example of a fully connected neural network, in accordance with aspects of the present disclosure;

FIG. 2B illustrates an example of a locally connected neural network, in accordance with aspects of the present disclosure;

FIG. 2C illustrates an example of a convolutional neural network (CNN), in accordance with aspects of the present disclosure;

FIG. 2D illustrates a detailed example of a deep convolutional network (DCN), in accordance with aspects of the present disclosure;

FIG. 3 is a block diagram illustrating an example of a deep convolutional network, in accordance with aspects of the present disclosure;

FIG. 4 is a block diagram illustrating an example system diagram for optimizing a machine learning model for parameter extraction, in accordance with aspects of the present disclosure;

FIG. 5 is a block diagram representing example results from performing parameter extraction, in accordance with aspects of the present disclosure;

FIG. 6 is a flow diagram representing an example scenario of performing parameter extraction, in accordance with aspects of the present disclosure;

FIG. 7 is a flow diagram representing an example process of performing parameter extraction, in accordance with aspects of the present disclosure;

FIG. 8 illustrates an example computing system which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

As noted previously, a machine learning models, such as large language models (LLMs), can be trained to process textual data to perform natural language processing tasks, such as generating, recognizing, extracting, predicting, translating, etc. text. One such natural language processing task can include extraction of elements from queries, and mapping of the extracted elements to categories, other elements, or other data.

Challenges remain in integrating many machine learning models into portable electronic devices such as smartphones, smart watches, tablets etc. For example, LLMs can be particularly difficult to integrate into portable electronic devices because of the size and resource intensive nature of executing many LLMs. The challenges in integrating machine learning models into portable electronic devices often stem from hardware restraints, such as lower processing power and memory compared to desktops and servers.

Another challenge faced when using machine learning models is ensuring reliability and accuracy of parameter extraction and mapping. Current machine learning models (e.g., LLMs or other models) can struggle with responding to requests lacking context or sufficient information. In some examples, machine learning models can be prone to generating incorrect or seemingly fabricated information (referred to as hallucinations) when presented with a request lacking sufficient context. Hallucinations can be especially problematic because machine learning models generally present the hallucinations as accurate to users. The hallucinations are not always immediately evident as incorrect or fabricated, requiring users to regularly audit machine learning model outputs for accuracy.

In the context of parameter extraction for application programming interface (API) calling, an individual query often lacks a sufficient amount of context for a machine learning model to predict every necessary parameter (e.g., keys) of an API. Queries can be sentences represented by one or more strings of characters. A query can include a request by a user to perform an action. Sometimes, multiple queries are needed before every necessary parameter for an API is provided. Even in examples where all of the parameters of an API are known to the machine learning model at the outset of receiving a query, the parameters and values associated with the queries may still not be known.

One example method for resolving the issue of extracting values in queries for unknown parameters of an API includes the machine learning model assuming values associated with all parameters of the API are present in each query. The machine learning model can attempt to extract values associated with all of the parameters sequentially for each query. For example, the machine learning model can extract values from the query corresponding to the parameters of the API. For the parameters that do not have a corresponding value not present in the query, the machine learning model can assign the parameters a “null” value. The method incurs latency because the method is inefficient. For example, because the machine learning model attempts to extract values from each of the queries for all of the parameters, the machine learning model can perform the same tasks multiple times.

Systems, apparatuses, electronic devices, methods (also referred to as processes), and computer-readable media (collectively referred to herein as “systems and techniques”) are described herein for optimizing parameter extraction for API calling. The machine learning model can include any type of model, such as an LLM, a classification model, a transformer model, etc.

According to some aspects, the systems and techniques described herein can predict relevant keys present in a query. For example, a set of keys for an API or plurality of APIs can be known to the machine learning model. The machine learning model can receive a query. The machine learning model can be fine-tuned to recognize keys associated with the query (e.g., keys that are present in the query and for which values from the query are to be extracted). For example, the query can be a request to book a flight. In such an example, the query can include a sentence stating, “I would like to travel to New York from San Diego”. The machine learning model can use techniques such as named entity recognition (NER) to identify New York and San Diego are locations. The machine learning model can predict, based on the query including two locations, two keys that are present in the query and can then predict corresponding values for the keys from the query. For example, the machine learning model can predict that keys associated with an origin and a destination for booking the flight are associated with the query “I would like to travel to New York from San Diego”. The machine learning model can then predict values from the query that are associated with the origin and destination. Based on the prediction, the machine learning model can extract the values from the query that are associated with the origin and destination. In continuing the example, the key for origin can be associated with the value “New York” and the key for destination can be associated with the value “San Diego”.

Each API can have an associated set of keys representing a total key space of the API. The total key space of the API can be represented by p={p₁, p₂, . . . p_{N}} where p includes all of the possible keys for an API (e.g., an entire parameter set of the API, a superset of parameters associated with the API). The machine learning model can prepare a subset of the set of keys represented by r={ [symbol] , [symbol] , . . . [symbol] }, with r⊂p. The subset can represent the keys predicted by the machine learning model to be associated with values in one or more queries. The subset of keys can be referred to as the “relevant keys” because the subset of keys are the keys the machine learning model predicts based on the queries. The machine learning model can be configured to solve the following: r=g(p, Q), where g is the machine learning model configured to receive as input the entire parameter space of the given API, and the query Q. The machine learning model can predict the relevant keys based on the total key space of the API and the query.

In some aspects, the machine learning model can predict values associated with the relevant keys and can extract the predicted values. For example, the machine learning model can extract values that are part of a key-value pair representing a mapping of a value from a query to a predicted key. A key-value pair can include a key and a value (extracted from a query) that is associated with the key. Values can be represented by numbers, characters, phrases, strings of characters, etc. The machine learning model can provide the values associated with the keys (or the key-value pairs) to the API. An application associated with the API can receive the values (or the key-value pairs) and perform actions based on the values (or the key-value pairs). In continuing the example above, the API can receive (or can determined based on the received values) key-value pairs represented as “origin=New York” and “destination=San Diego”. An application associated with the API (e.g., a flight booking application) can use the key-value pairs to populate a form and book a flight originating in New York and flying to San Diego.

In some examples, the machine learning model can predict keys from queries using in-context examples. The in-context examples can include past queries, keys, values, and APIs encountered by the machine learning model. For example, the machine learning model or a training engine can construct a dataset including various queries, APIs, sets of keys representing an entire key space of an API, and subsets of the sets keys representing relevant keys. For example, queries can be represented as a list or vector: Q={q₁, q₂, . . . qₙ} where each q₁ to qₙ are past queries encountered by the machine learning model or another instance of the machine learning model. The APIs associated with each query of Q can be represented as a list or vector: A={a₁, a₂, . . . aₙ}. The APIs from the vector correspond to the queries from the vector of queries (e.g., a₁ is associated with q₁, a₂ is associated with q₂, etc.). Each API includes a key set representing an entire key space of the API (e.g., every possible parameter of the API). The key set can be represented as {pᵢ}={p₁ᵢ, p₂ᵢ, . . . pₙᵢ} with aᵢ being associated with {pᵢ}. Each query is associated with a subset of a corresponding key set {pᵢ}. The subset represents relevant keys to a corresponding query (e.g., the keys present in the query). Each query qᵢ corresponds to the relevant keys rᵢ where rᵢ is a subset of pᵢ (e.g., {rᵢ}⊂{pᵢ}).

The machine learning model or a training engine can construct the dataset for in-context learning based on various semantic similarities between the queries, keys, and APIs. The machine learning model or training engine can identify semantic similarities using embedding representations (e.g., embedding vectors) of the queries, keys, and APIs. The machine learning model or training engine can use distance and angle techniques (e.g., cosine similarity, Euclidean distance, measurements between positions, etc.) to identify semantic similarities based on positions of the embedding representations in an embedding space. In further examples, the machine learning model can use semantic parsing of the elements to convert queries, keys, and APIs into logical representations which can be compared to one another to identify semantic similarities.

In one example, the machine learning model or training engine can determine semantic similarities between a key set of a query (e.g., the most recently received query) to relevant key sets (e.g., a subset of a key set representing a total key space of an API) of past queries. For example, the semantic similarity can be represented as [s,{ [symbol] }] and [qᵢ,{pᵢ}] with s representing a query and { [symbol] } representing the total key space of an API associated with query s. The machine learning model or training engine can select a top-k example (e.g., an example with the highest semantic similarity) from [qᵢ,{pᵢ}] to use as an in-context example.

In another example, the machine learning model or training engine can determine semantic similarities between a query and past queries (e.g., semantic similarities between [s] and [qᵢ]). The machine learning model or training engine can select a top-k example from qᵢ to use as the in-context example.

In a further example, the machine learning model or training engine can determine semantic similarities between a query and APIs associated with past queries. Further examples can include determining semantic similarity between a query and descriptions of APIs associated with past queries.

The top-k examples determined based on semantic similarities can include [qᵢ, aᵢ, {pᵢ}, {rᵢ}] (e.g., queries, API names/descriptions, a key set representing the total key space, and relevant key sets). The top-k examples can be provided to the machine learning model to use as in-context examples. The machine learning model using in-context learning can be represented by r=g(R, s) where r is the output of the machine learning model and g represents the machine learning model. R represents the top-k examples and s represents a query. The machine learning model can generate outputs based on the top-k examples and a query.

The machine learning model can be trained using various training techniques such as iterative loss training techniques to minimize a loss function. In some examples, the training engine can compare differences between the output of the machine learning model differences and an expected output. For example, the training engine can compare embedding representations of the output and the expected output using various distance-based techniques. The training engine can compare a position of an embedding representation associated with output and a position associated with an embedding representation in an embedding space. The training engine can adjust weights and other parameters of the machine learning model to reduce difference between the machine learning model output and the expected output (e.g., by fine-tuning the machine learning model). In some examples, the loss function for all keys is equally weighted for all the key fields in query. In further examples, the weights of the loss function or machine learning model can be higher for particular key fields (e.g., for required key fields, which are key fields necessary for an API to perform tasks). For example, an API associated with an application for booking flights can have required key fields for an origin and destination because the application would be unable to book a flight without at least information for the required key fields.

Various aspects of the present disclosure will be described with respect to the figures.

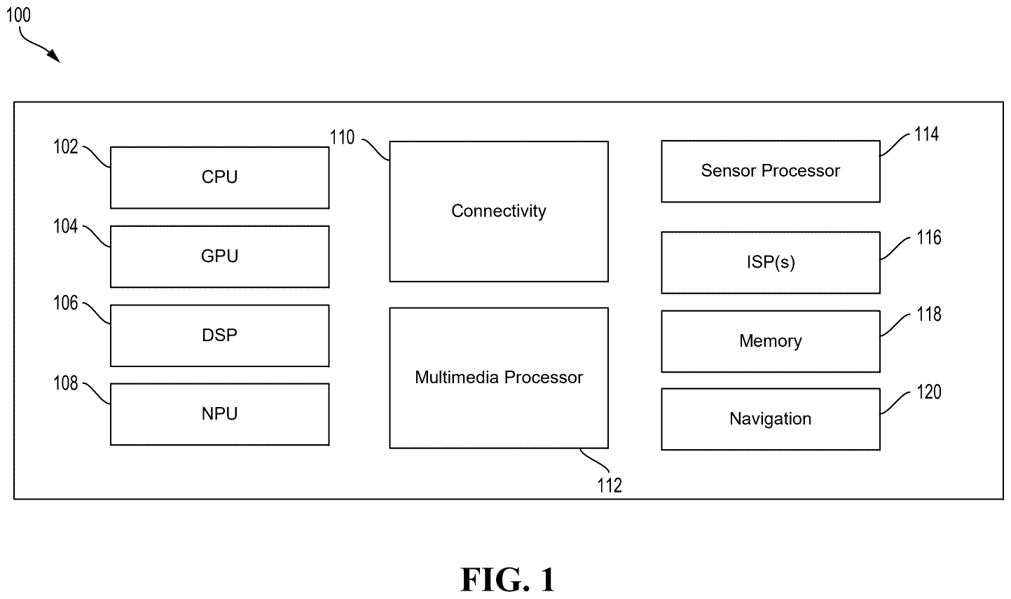

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 which can, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. SOC 100 and/or components thereof may be configured to perform segmentation mask extrapolation. For example, the CPU 102, DSP 106, and/or GPU 104 may be configured to perform object detection using a visual language model via latent feature adaptation with synthetic data.

In some cases, the SOC 100 may process data using neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For example, higher layers can learn to represent complex shapes in visual data or words in auditory data. Still higher layers can learn to recognize common visual objects or spoken phrases.

Deep learning architectures can perform especially well when applied to problems that have a natural hierarchical structure. For example, the classification of motorized vehicles can benefit from first learning to recognize wheels, windshields, and other features. These features may be combined at higher layers in different ways to recognize cars, trucks, and airplanes.

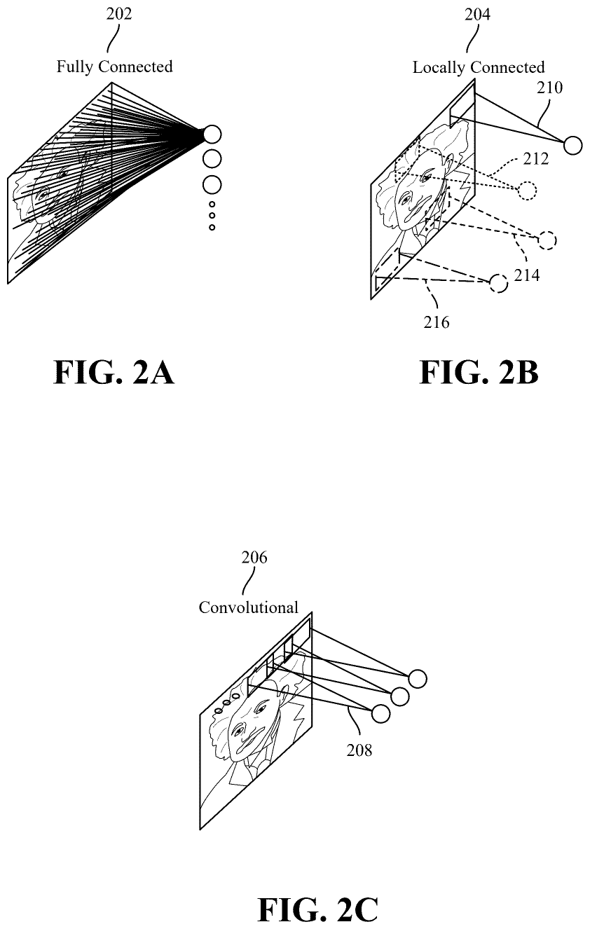

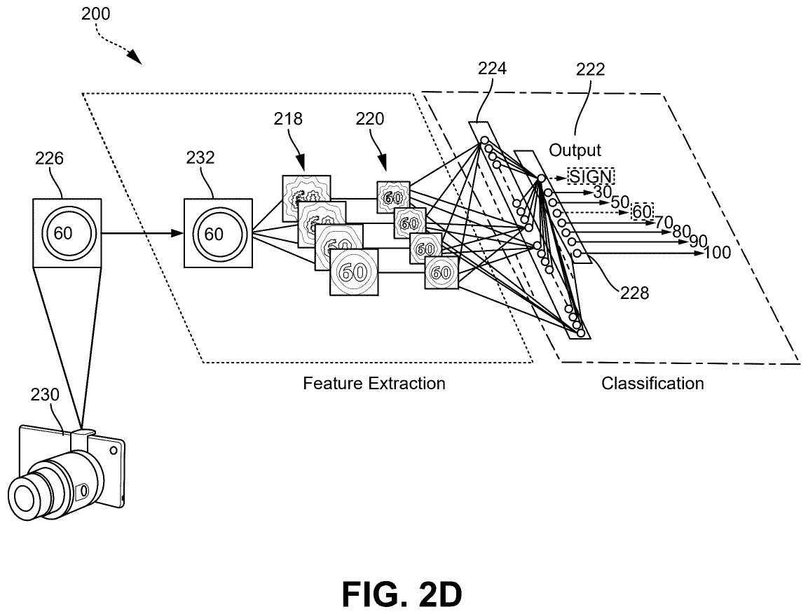

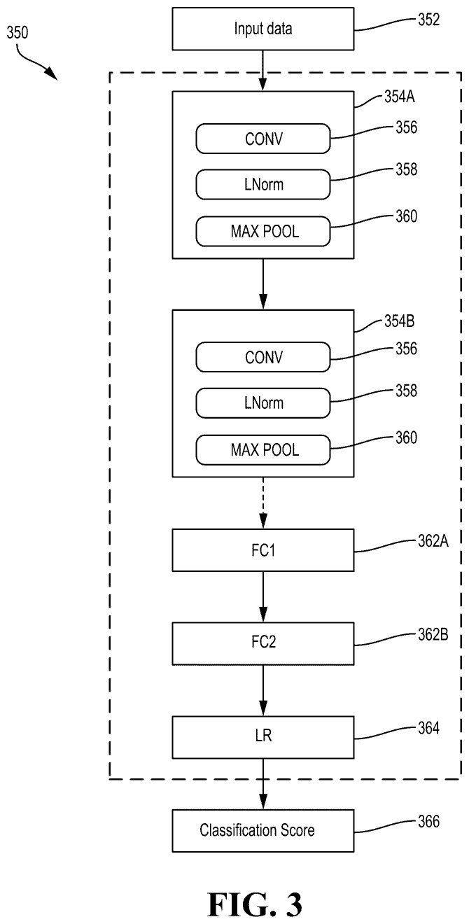

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 2A-FIG. 3.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decom-pression, according to aspects of the present disclosure.

One type of convolutional neural network is a deep convolutional network (DCN). FIG. 2D illustrates a detailed example of a DCN 200 designed to recognize visual features from an image 226 input from an image capturing device 230, such as an image capture and processing system based on SOC 100 of FIG. 1. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. Adjusting the weights in such a manner may be referred to as “back propagation” as it involves a “backward pass” through the neural network.

In practice, the error gradient of weights may be calculated over a small number of examples, so that the calculated gradient approximates the true error gradient. The approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and out-put targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 220) receiving input from a range of neurons in the previous layer (e.g., feature maps 218) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

FIG. 3 is a block diagram illustrating an example of a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Of note, the layers illustrated with respect to convolution blocks 354A and 354B are examples of layers that may be included in a convolution layer and are not intended to be limiting and other types of layers may be included in any order.

The convolution layers 356 may include one or more convolutional filters, which may be ap-plied to the input data 352 to generate a feature map. Although only two convolution blocks 354A, 354B are shown, the present disclosure is not so limiting, and instead, any number of convolution blocks (e.g., convolution blocks 354A, 354B) may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

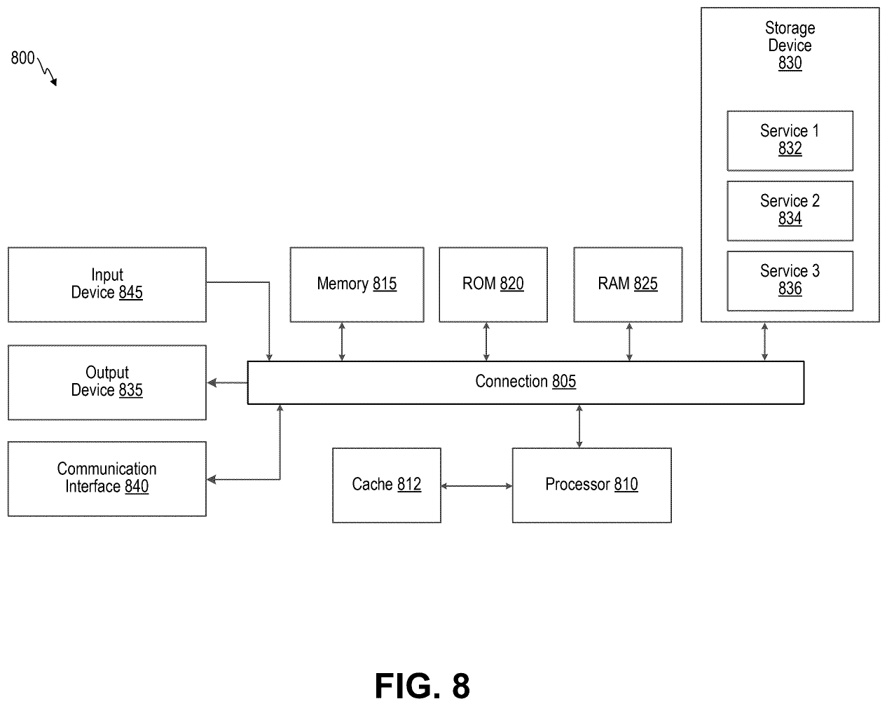

The parallel filter banks, for example, of a deep convolutional network may be loaded on a processor such as a CPU, GPU, NPU, or any other type of processor 810 discussed with respect to the computing system 800 of FIG. 8 to achieve high performance and low power consumption. In alternative aspects, the parallel filter banks may be loaded on a DSP or an ISP of the computing system 800. In addition, the deep convolutional network 350 may access other processing blocks that may be present on the computing system 800 of FIG. 8, such as a sensor processor and navigation module, dedicated, respectively, to sensors and navigation.

The deep convolutional network 350 may also include one or more fully connected layers, such as layer 362A (labeled “FC1”) and layer 362B (labeled “FC2”). The deep convolutional network 350 may further include a logistic regression (LR) layer 364. Between each layer 356, 358, 360, 362A, 362B, 364 of the deep convolutional network 350 are weights (not shown) that are to be updated. The output of each of the layers (e.g., 356, 358, 360, 362A, 362B, 364) may serve as an input of a succeeding one of the layers (e.g., 356, 358, 360, 362A, 362B, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

In some cases, one or more convolutional networks, such as a DCN, may be incorporated into more complex ML networks. As an example, as indicated above, the deep convolutional network 350 may output probabilities that an input data, such as an image, includes certain features. The deep convolutional network 350 may then be modified to extract (e.g., output) certain features. Additionally, DCNs may be added to extract other features as well. The set of DCNs may function as feature extractors to identify features in an image. In some cases, feature extractors may be used as a backbone for additional ML network components to perform further operations, such as image segmentation, extraction of elements from queries, classifying extracted elements, and mapping extracted elements to input parameters.

In some cases, CNN and/or DCNs may be generalized in the form of a transformer network. A transformer network may extract features from an input sequence and the transformer network may include attention mechanisms that may enable the transformer network to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer network may include a series of feedforward layers whose configurations may change in response to identifying non-linear relationships between the input and output sequences, which may also be referred to as a process of “learning” by the layers. The output of a transformer structure may be obtained by applying a linear transformation to the output of a final attention layer. A transformer structure may be of particular use for tasks that involve sequence modeling, text generation, or other like processing.

The neural network architectures described in FIGS. 2A-2D and FIG. 3 can also be used as the architecture of a machine learning model configured to perform tasks involving named entity recognition, natural language processing, extracting keys, extracting key-value pairs, determining semantic similarities, and providing key-value pairs to an API. In some examples, the neural network architectures described in FIGS. 2A-2D and FIG. 3 can provide the architecture for a large language model (LLM).

As noted previously, systems and techniques are described herein for optimizing a machine learning model for providing inputs to an of an application programming interface (API)). The systems and techniques can make use of multiple machine learning models, such as an LLM, a classification model, etc., which in some cases can include the neural network architectures described with respect to FIGS. 2A-2D and FIG. 3 and/or other neural network architectures (e.g., using one or more transformer neural network architectures).

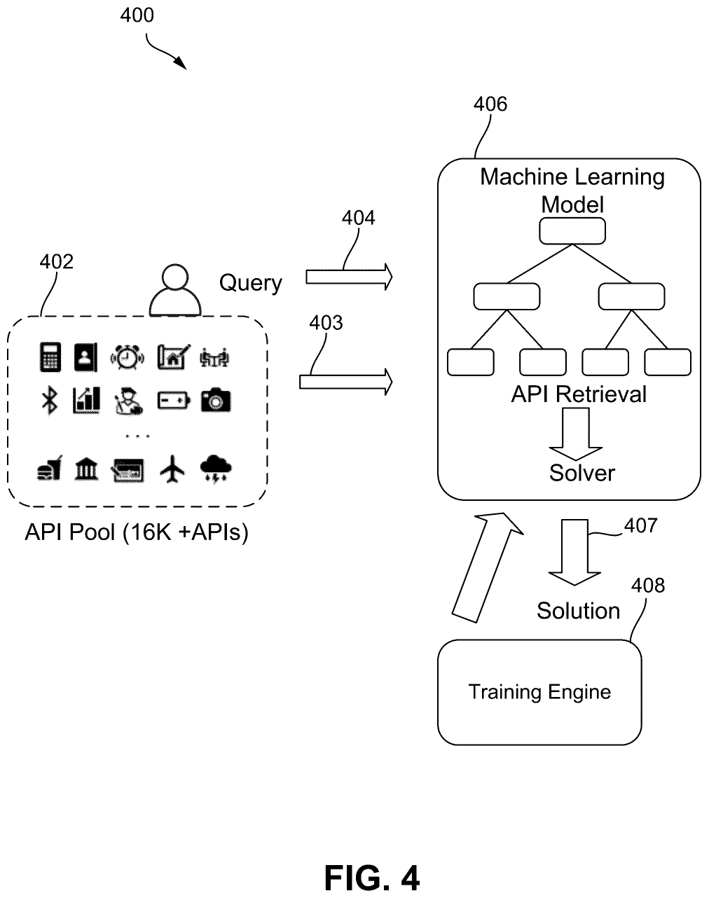

FIG. 4 is a block diagram illustrating an example system 400 diagram for optimizing a machine learning model for parameter extraction. The example system 400 includes an application programming interface (API) pool 402, key sets 403, a query 404, a machine learning model 406, an output 407 of machine learning model 406, and a training engine 408. Further description of the machine learning architecture is provided in the descriptions of FIGS. 2A-2D and FIG. 3.

The API pool 402 represents a set of all APIs that can provide key sets to the machine learning model 406. In some examples, API pool 402 is a database of APIs and key sets 403 associated with each API. Each API of the API pool 402 can include key sets 403 associated with the API. The key sets 403 represent a key space of all possible keys (e.g. input parameters) to the API that an application associated with the API uses to perform actions. For example, an API associated with an application for booking flights can include key sets 403 including input parameters such as departure date, origin, destination, number of passengers, etc. The API pool 402 can provide the key sets 403 to the machine learning model 406. In some examples, the machine learning model 406 can retrieve the key sets 403 based on a user selection. In some examples, the user selection can be part of the query 404. The user provides the query 404 to the machine learning model 406, such as by typing a request into an input field of an application associated with the machine learning model 406. In further examples, the machine learning model 406 can infer the API to use based on the query 404. The machine learning model 406 can retrieve key sets 403 from the API pool 402 based on the inference.

The machine learning model 406 can predict keys from the key set 403 associated with a query. Based on the predicted keys, the machine learning model 406 can predict values associated with the predicted keys. Values can be represented by numbers, characters, strings etc. The machine learning model 406 can extract the predicted values. The machine learning model 406 can provide the values (or the key-value pairs) to the API (e.g., an API from the API pool 402). An application associated with the API can receive the values (or the key-value pairs) and perform actions based on the values (or the key-value pairs).

For example, the query can be a request to book a flight. In such an example, the query can include a sentence stating, “I would like to travel to New York from San Diego”. The machine learning model 406 can use techniques such as named entity recognition (NER) to predict keys in a query 404 and predict values associated with the keys.

Each API from the API pool 402 can have an associated set of keys representing a total key space of the API. The total key space of the API can be represented by p={p₁, p₂, . . . p_{N}} where p includes all of the possible keys for an API (e.g., an entire parameter set of the API, a superset of parameters associated with the API). The machine learning model 406 can prepare a subset of the set of keys represented by r={ [symbol] , [symbol] , . . . [symbol] }, with r⊂p. The subset can represent the keys predicted by the machine learning model 406 to have corresponding values present in the query 404.

The machine learning model 406 can provide an output 407 value (or the key-value pairs) to an API from the API pool 402. In some examples, the machine learning model 406 can provide the output 407 to a training engine 408. In some examples, the training engine 408 can be used to fine-tune weights or parameters of the machine learning model 406. In further examples, the training engine 408 can construct a dataset for in-context learning using the machine learning model 406 based on various semantic similarities between the queries, keys, and APIs. The training engine 408 can identify semantic similarities using embedding representations (e.g., embedding vectors) of the queries, keys, and APIs. The training engine 408 can use distance and angle techniques (e.g., cosine similarity, Euclidean distance, etc.) to identify semantic similarities based on positions of the embedding representations in an embedding space. In further examples, the training engine 408 can use semantic parsing of the elements to convert queries, keys, and APIs into logical representations which can be compared to one another to identify semantic similarities.

In one example, the training engine 408 can determine semantic similarities between the key set 403 associated with query 404 to relevant key sets (e.g., a subset of a key set representing a total key space of an API) of past queries. The training engine 408 can select a top-k example (e.g., an example with the highest semantic similarity) from the past queries to use as an in-context example.

The machine learning model 406 can be trained using various training techniques such as iterative loss training techniques to minimize a loss function. In some examples, the training engine 408 can compare differences between the output 407 and an expected output of the machine learning model 406. For example, the training engine 408 can use various distance-based techniques to compare embedding representations of the output 407 and the expected output. The training engine 408 can adjust weights and other parameters of the machine learning model 406 to reduce differences between the output 407 and the expected output (e.g., by fine-tuning the machine learning model). In some examples, the loss function of the machine learning model 406 is equally weighted for predicting keys from the query 404. In further examples, the weights of the loss function or machine learning model can be higher for required keys (e.g., keys that are necessary for an API to perform tasks).

In some aspects, training of one or more of the machine learning systems or neural networks described herein (e.g., such as the neural networks of FIGS. 2A-2D and FIG. 3, among various other machine learning networks described herein) can be performed using online training (e.g., in some case on-device training), offline training, and/or various combinations of online and offline training. In some cases, online can refer to time periods during which the input data (e.g., such as an input query to a large language model (LLM), etc.) is processed, for example for performance of optimizing weights of the neural network so that the neural network is more easily quantized (e.g., requires less resources to quantize) while maintaining accuracy of the neural network. In some examples, offline can refer to idle time periods or time periods during which input data is not being processed. Additionally, offline can be based on one or more time conditions (e.g., after a particular amount of time has expired, such as a day, a week, a month, etc.) and/or can be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

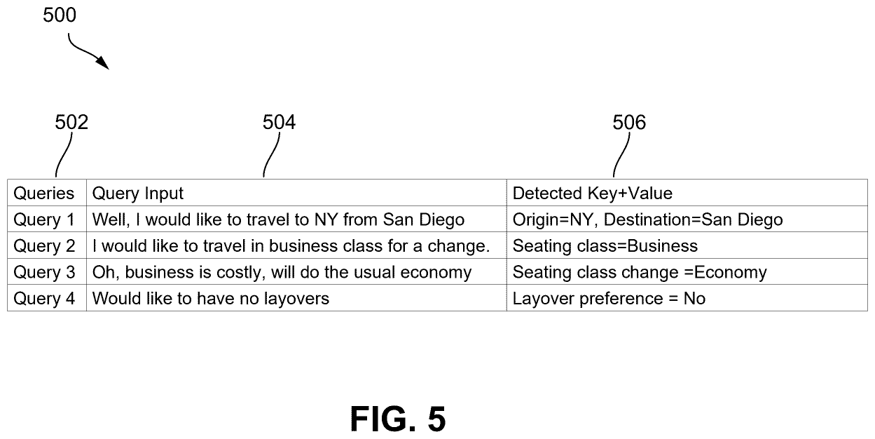

FIG. 5 is a block diagram 500 representing example results from performing parameter extraction. Block diagram 500 illustrates the results of performing parameter extraction (e.g., predicting keys and extracting values associated with the predicted keys) using a machine learning model such as machine learning model 406 from FIG. 4. Block diagram 500 illustrates the results in three columns. A first column 502 indicates an order and number of queries. By way of example, the machine learning model predicting keys and extracting values from the queries received four queries. A second column 504 illustrates contents of the four queries. The four queries from the first column 502 are illustrated as sentences. Users can type into input fields of an application to provide queries to a machine learning model. In some examples, the machine learning model can receive the queries as sentences. In other examples, the machine learning model can receive the queries as embedding representations of the sentences.

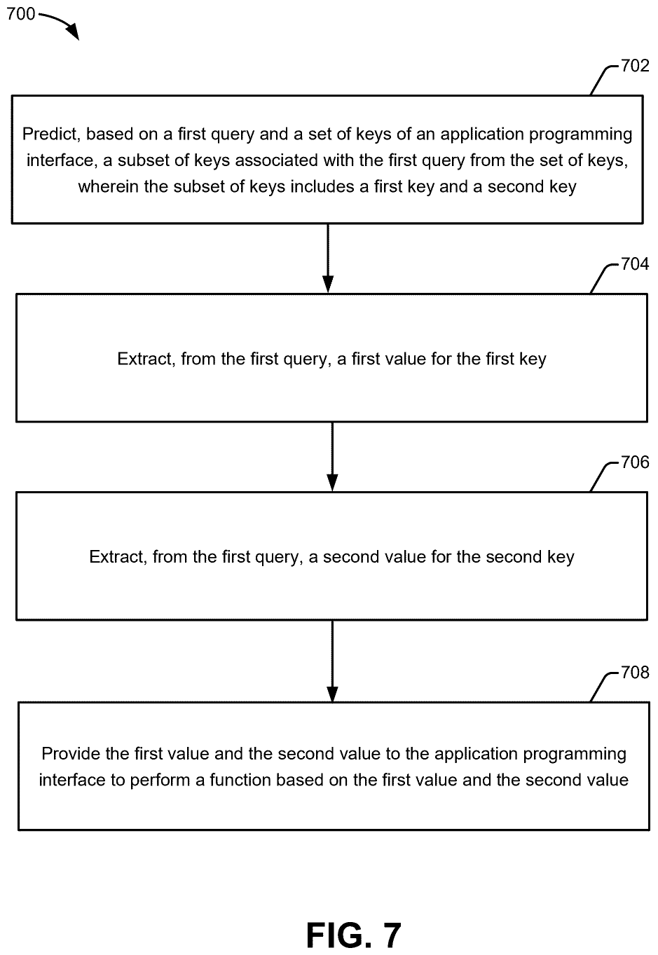

The queries from the first column 502 include a value associated with the predicted key as illustrated by key-value pairs in a third column 506. The keys of the third column 506 represent a subset of a broader set of keys associated with an API (e.g., the relevant keys further described in the description of FIG. 4). Each subsequent query provided more context for performing the task requested by the user. As further described in the description of FIG. 4 and FIG. 7, the machine learning model can predict a key based on a query. The machine learning model can predict a value associated with the predicted key. The machine learning model can extract the predicted value from the query. The third column illustrates example key-value pairs. In some examples, the machine learning model can provide the key-value pairs to an API. In further examples, the machine learning model provides the values to the API.

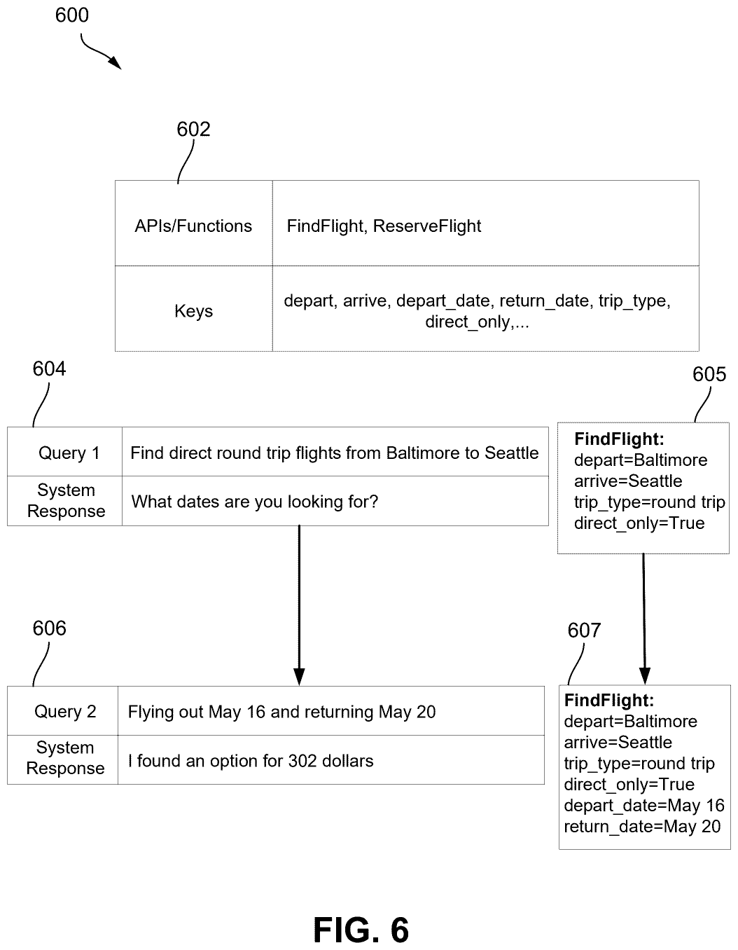

FIG. 6 is a flow diagram representing an example scenario 600 of performing parameter extraction based on queries. Scenario 600 includes an application programming interface (API) 602. The API 602 includes parameters (e.g., keys) and a description of the API 602, such as a title (e.g., “FindFlight, “ReserveFlight”). The keys represent a key set for a total key space of the API 602 (e.g., every possible key that can be received by the API).

Block 604 represents a first query received by the machine learning model, and response by a system providing the machine learning model. For example, the machine learning model (e.g., machine learning model from FIG. 2A-2D, FIG. 3, FIG. 4, etc.) can assist applications, such as chatbots, process user queries. At block 604, a system response is provided to the user requesting more information. In some examples, another machine learning model, such as an LLM or chatbot, can respond to user queries.

Block 605 illustrates key-value pairs predicted by the machine learning model based on the query. Further description of predicting keys and extracting values is provided in the description of FIG. 4 and FIG. 7. The keys illustrated in block 605 illustrate a subset of the key set for the total key space of API 602. The machine learning model can use the subset to predict values from the query associated with keys from the subset.

Block 606 illustrates a second query received by the machine learning model. The second query provides additional context for performing the task requested by the user. The machine learning model can predict keys based on the second query and extract values from the second query. The keys based on the second query can be added to the subset of keys, as shown by the addition of “depart_date” and “return_date” to block 607. Block 607 illustrates an updated subset of keys and updated set of key-value pairs associated with the first query and the second query.

An application associated with the API 602 can perform an action when the API 602 receives all required key-value pairs or values for performing the action. By way of example, API 602 is associated with a flight booking application. After receiving key-value pairs associated with the first query and the second query, the application associated with API 602 can book a flight for the user based on the received key-value pairs.

FIG. 7 is a flow diagram illustrating an example of a process 700 for optimizing a machine learning model for performing parameter extraction. The process 700 can be performed by a computing device (e.g., SOC 100 of FIG. 1, computing device or computing system 800 of FIG. 8, etc.) or by a component or system (e.g., the neural networks of FIGS. 2A-2D and FIG. 3, a chipset, one or more processors central processing units (CPUs), digital signal processors (DSPs), graphics processing units (GPUs), any other type of processor(s), any combination thereof, or other component or system) of the computing device. The operations of the process 700 can be implemented as software components that are executed and run on one or more processors (e.g., processor 810 of FIG. 8 or other processor(s)) of the computing device. Further, the transmission and reception of signals by the computing device in the process 700 can be enabled, for example, by one or more antennas and/or one or more transceivers (e.g., wireless transceiver(s)).

At block 702, a processor (or component thereof) can predict, based on a first query and a set of keys of an application programming interface, a subset of keys associated with the first query from the set of keys. The subset of keys can include a first key and a second key. In some examples, the query is a user prompt, such as a text-based request for performance of a task. For example, the query can be a text-based request (e.g., a string) to book a flight such as “I would like to travel from Atlanta to New York.” The application programming interface can be an application programming interface associated with an application for booking flights. In some examples, the set of keys are input parameters associated with the application programming interface. For example, when the application programming interface is associated with an application for booking flights, the set of keys can be input parameters associated with booking a flight using the application, such as a departure date, origin, destination, number of passengers, return date, etc. The subset of keys is predicted based on the text-based request and the set of keys. For example, for the text-based request “I would like to travel from Atlanta to New York” the subset of keys can include keys such as origin and destination.

At block 704, the processor (or component thereof) can extract, from the first query, a first value for the first key. For example, where the query is the text-based request “I would like to travel from Atlanta to New York” and the first key is associated with a destination, the first value can be “Atlanta” from the first query. In some examples, the extraction can be performed by a machine learning model performing named entity recognition.

At block 706, the processor (or component thereof) can extract, from they first query, a second value for the second key. In continuing the example where the query is “I would like to travel from Atlanta to New York” and the second key is associated with an origin, the second value can be “New York”.

At block 708, the processor (or component thereof) can provide the first value and the second value to the application programming interface to perform a function based on the first value and the second value. For example, the application programming interface can receive the first value “Atlanta” and “New York”. The application associated with the application programming interface can book a flight from Atlanta to New York based on the first value and the second value.

FIG. 8 is a diagram illustrating an example of a system for implementing certain aspects of the present technology. In particular, FIG. 8 illustrates an example of computing system 800, which can be for example any computing device making up internal computing system, a remote computing system, a camera, or any component thereof in which the components of the system are in communication with each other using connection 805. Computing system 800 can be for example any computing device making up SOC 100, fully connected neural network 202, locally connected neural network 204, convolutional neural network 206, neural network 300, the machine learning model 406 of FIG. 4, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some aspects, computing system 800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 800 includes at least one processor, such as a central processing unit (CPU), graphics processing unit (GPU), neural processing unit (NPU), digital signal processor (DSP), image signal processor (ISP), a field programmable gate array (FPGA), an application specific integrated circuit (ASIC), a microprocessor, a controller, another type of processing unit, another suitable electronic circuit, or a combination thereof. The computing system 800 also includes a connection 805 that couples various system components including system memory 815, such as read-only memory (ROM) 820 and random-access memory (RAM) 825 to processor 810. Computing system 800 can include a cache 812 of high-speed memory connected directly with, in close proximity to, or integrated as part of processor 810. In some aspects, the processor 810 (in some cases in combination with one or more other components, such as the ROM 820 and/or RAM 825) can perform any of the techniques described herein, such as the techniques described with respect to the machine learning model 406 of FIG. 4, the machine, and/or the process 700 of FIG. 7.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 can essentially be a completely self-contained computing system, containing multiple cores or processors, a bus, memory controller, cache, etc. A multi-core processor can be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output. The communication interface can perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 702.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 can also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here can easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc. When the code that defines such software is executed by the processor 810, the code causes the system to perform a function. In some aspects, a hardware service that performs a particular function can include the software component stored in a computer-readable medium in connection with the necessary hardware components, such as processor 810, connection 805, output device 835, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium can include a non-transitory medium in which data can be stored and that does not include carrier waves and/or transitory electronic signals propagating wirelessly or over wired connections. Examples of a non-transitory medium can include, but are not limited to, a magnetic disk or tape, optical storage media such as compact disk (CD) or digital versatile disk (DVD), flash memory, memory or memory devices. A computer-readable medium can have stored thereon code and/or machine-executable instructions that can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects can be practiced without these specific details. For clarity of explanation, in some instances the present technology can be presented as including individual functional blocks including functional blocks comprising devices, device components, steps or routines in a method embodied in software, or combinations of hardware and software. Additional components can be used other than those shown in the figures and/or described herein. For example, circuits, systems, networks, processes, and other components can be shown as components in block diagram form in order not to obscure the aspects in unnecessary detail. In other instances, well-known circuits, processes, algorithms, structures, and techniques can be shown without unnecessary detail in order to avoid obscuring the aspects.

Individual aspects can be described above as a process or method which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed but could have additional steps not included in a figure. A process can correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions can be, for example, binaries, intermediate format instructions such as assembly language, firmware, source code, etc. Examples of computer-readable media that can be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) can be stored in a computer-readable or machine-readable medium. A processor(s) can perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts can be otherwise variously embodied and employed, and that the appended claims are intended to be construed to include such variations, except as limited by the prior art. Various features and aspects of the above-described application can be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods can be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein can be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present application.

The techniques described herein can also be implemented in electronic hardware, computer software, firmware, or any combination thereof. Such techniques can be implemented in any of a variety of devices such as general purposes computers, wireless communication device handsets, or integrated circuit devices having multiple uses including application in wireless communication device handsets and other devices. Any features described as modules or components can be implemented together in an integrated logic device or separately as discrete but interoperable logic devices. If implemented in software, the techniques can be realized at least in part by a computer-readable data storage medium comprising program code including instructions that, when executed, performs one or more of the methods described above. The computer-readable data storage medium can form part of a computer program product, which can include packaging materials. The computer-readable medium can comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, can be realized at least in part by a computer-readable communication medium that carries or communicates program code in the form of instructions or data structures and that can be accessed, read, and/or executed by a computer, such as propagated signals or waves.

The program code can be executed by a processor, which can include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor can be configured to perform any of the techniques described in this disclosure. A general-purpose processor can be a microprocessor; but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein can refer to any of the foregoing structure, any combination of the foregoing structure, or any other structure or apparatus suitable for implementation of the techniques described herein. In addition, in some aspects, the functionality described herein can be provided within dedicated software modules or hardware modules configured for encoding and decoding or incorporated in a combined video encoder-decoder (CODEC).

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor can only perform at least a subset of operations X, Y, and Z.

Illustrative aspects of the disclosure include:

Aspect 1: An apparatus for optimizing parameter extraction, the apparatus comprising: at least one memory; and at least one processor coupled to the at least one memory and configured to: predict, based on a first query and a set of keys of an application programming interface, a subset of keys associated with the first query from the set of keys, wherein the subset of keys comprises a first key and a second key; extract, from the first query, a first value for the first key; extract, from the first query, a second value for the second key; and provide the first value and the second value to the application programming interface to perform a function based on the first value and the second value.

Aspect 2: The apparatus of Aspect 1, wherein the at least one processor is configured to: extract the first value and the second value using a machine learning model configured to perform named entity recognition.

Aspect 3: The apparatus of any of Aspects 1 to 2, wherein the first value and the second value are predicted values.

Aspect 4: The apparatus of any of Aspects 1 to 3, wherein the at least one processor is configured to: determine the application programming interface based on the first key and the second key.

Aspect 5: The apparatus of any of Aspects 1 to 4, wherein the at least one processor is configured to: determine, based on the first query, a subset of keys from the set of keys, wherein the subset of keys includes the first key and the second key.

Aspect 6: The apparatus of Aspect 5, wherein the at least one processor is configured to: predict a third key based on a semantic similarity of a second set of keys and the subset of keys, wherein the second set of keys is associated with a third query.

Aspect 7: The apparatus of any of Aspects 5 or 6, wherein the at least one processor is configured to: predict a plurality of values associated with the subset of keys and the first query, wherein each value of the plurality of values is associated with one or more keys from the subset of keys.

Aspect 8: The apparatus of any of Aspects 1 to 7, wherein the at least one processor is configured to: predict the first key based on a distance measurement of an embedding vector associated with the first key and an embedding vector associated with the set of keys.

Aspect 9: The apparatus of Aspect 8, wherein the at least one processor is configured to: predict the first key using a machine learning model.

Aspect 10: The apparatus of Aspect 9, wherein the machine learning model is trained using a loss function with higher weights provided for extraction of a predetermined plurality of keys.

Aspect 11: The apparatus of Aspect 10, wherein the machine learning model is trained using on-device training.

Aspect 12: A method for optimizing parameter extraction, the method comprising: predicting, based on a first query and a set of keys of an application programming interface, a subset of keys associated with the first query from the set of keys, wherein the subset of keys comprises a first key and a second key; extracting, from the first query, a first value for the first key; extracting, from the first query, a second value for the second key; and providing the first value and the second value to the application programming interface to perform a function based on the first value and the second value.

Aspect 13: The method of any of Aspects 12 to 13, further comprising: extracting the first value and the second value using a machine learning model configured to perform named entity recognition.

Aspect 14: The method of any of Aspects 12 to 13, wherein the first value and the second value are predicted values.

Aspect 15: The method of any of Aspects 12 to 14, further comprising: determining the application programming interface based on the first key and the second key.

Aspect 16: The method of any of Aspects 12 to 15, further comprising: determining, based on the first query, a subset of keys from the set of keys, wherein the subset of keys includes the first key and the second key.

Aspect 17: The method of Aspect 16, further comprising: predicting a third key based on a semantic similarity of a second set of keys and the subset of keys, wherein the second set of keys is associated with a third query.

Aspect 18: The method of any of Aspects 16 or 17, further comprising: predicting a plurality of values associated with the subset of keys and the first query, wherein each value of the plurality of values is associated with one or more keys from the subset of keys.

Aspect 19: The method of any of Aspects 12 to 18, further comprising: predicting the first key based on a distance measurement of an embedding vector associated with the first key and an embedding vector associated with the set of keys.

Aspect 20: The method of any of Aspects 12 to 19, further comprising: predicting the first key using a machine learning model.

Aspect 21: The method of Aspect 20, wherein the machine learning model is trained using a loss function with higher weights provided for extraction of a predetermined plurality of keys.

Aspect 22: The method of Aspect 21, wherein the machine learning model is trained using on-device training.

Aspect 23: A non-transitory computer-readable medium having stored thereon instructions that, when executed by one or more processors, cause the one or more processors to perform operations according to any of Aspects 12 to 22.

Aspect 24: An apparatus for optimizing parameter extraction, the apparatus comprising one or more means for performing operations according to any of Aspects 12 to 22.

What is claimed is:

1. An apparatus for optimizing parameter extraction, the apparatus comprising:
at least one memory; and
at least one processor coupled to the at least one memory and configured to:
predict, based on a first query and a set of keys of an application programming interface, a subset of keys associated with the first query from the set of keys, wherein the subset of keys comprises a first key and a second key;
extract, from the first query, a first value for the first key;
extract, from the first query, a second value for the second key; and
provide the first value and the second value to the application programming interface to perform a function based on the first value and the second value.

2. The apparatus of claim 1, wherein the at least one processor is configured to:
extract the first value and the second value using a machine learning model configured to perform named entity recognition.

3. The apparatus of claim 1, wherein the first value and the second value are predicted values.

4. The apparatus of claim 1, wherein the at least one processor is configured to:
determine the application programming interface based on the first key and the second key.

5. The apparatus of claim 1, wherein the at least one processor is configured to:
determine, based on the first query, a subset of keys from the set of keys, wherein the subset of keys includes the first key and the second key.

6. The apparatus of claim 5, wherein the at least one processor is configured to:
predict a third key based on a semantic similarity of a second set of keys and the subset of keys, wherein the second set of keys is associated with a third query.

7. The apparatus of claim 5, wherein the at least one processor is configured to:
predict a plurality of values associated with the subset of keys and the first query, wherein each value of the plurality of values is associated with one or more keys from the subset of keys.

8. The apparatus of claim 1, wherein the at least one processor is configured to:
predict the first key based on a distance measurement of an embedding vector associated with the first key and an embedding vector associated with the set of keys.

9. The apparatus of claim 8, wherein the at least one processor is configured to:
predict the first key using a machine learning model.

10. The apparatus of claim 9, wherein the machine learning model is trained using a loss function with higher weights provided for extraction of a predetermined plurality of keys.

11. The apparatus of claim 10, wherein the machine learning model is trained using on-device training.

12. A method for optimizing parameter extraction, the method comprising:
predicting, based on a first query and a set of keys of an application programming interface, a subset of keys associated with the first query from the set of keys, wherein the subset of keys comprises a first key and a second key;
extracting, from the first query, a first value for the first key;
extracting, from the first query, a second value for the second key; and
providing the first value and the second value to the application programming interface to perform a function based on the first value and the second value.

13. The method of claim 12, further comprising:
extracting the first value and the second value using a machine learning model configured to perform named entity recognition.

14. The method of claim 12, wherein the first value and the second value are predicted values.

15. The method of claim 12, further comprising:
determining the application programming interface based on the first key and the second key.

16. The method of claim 12, further comprising:
determining, based on the first query, a subset of keys from the set of keys, wherein the subset of keys includes the first key and the second key.

17. The method of claim 16, further comprising:
predicting a third key based on a semantic similarity of a second set of keys and the subset of keys, wherein the second set of keys is associated with a third query.

18. The method of claim 16, further comprising:
predicting a plurality of values associated with the subset of keys and the first query, wherein each value of the plurality of values is associated with one or more keys from the subset of keys.

19. The method of claim 12, further comprising:
predicting the first key based on a distance measurement of an embedding vector associated with the first key and an embedding vector associated with the set of keys.

20. A non-transitory computer readable medium storing code for optimizing parameter extraction, the code comprising instructions executable by a processor to:
predict, based on a first query and a set of keys of an application programming interface, a subset of keys associated with the first query from the set of keys, wherein the subset of keys comprises a first key and a second key;
extract, from the first query, a first value for the first key;
extract, from the first query, a second value for the second key; and
provide the first value and the second value to the application programming interface to perform a function based on the first value and the second value.
